(19) United States
(12) Patent Application Publication
(10) Pub. No.: US 2016/0323483 A1
(43) Pub. Date: Nov. 3, 2016

(54) AUTOMATICALLY GENERATING NOTES AND ANNOTATING MULTIMEDIA CONTENT SPECIFIC TO A VIDEO PRODUCTION

(71) Applicant: Invent.ly LLC, Woodside, CA (US)

(72) Inventor: Stephen J. Brown, Woodside, CA (US)

(21) Appl. No.: 14/698,386

(22) Filed: Apr. 28, 2015

(51) Int. Cl. H04N 5/222; G06F 17/24; H04N 5/247; G11B 27/11

(52) U.S. Cl. CPC H04N 5/2228; G11B 27/11; G06F 17/241; H04N 5/247

(57) ABSTRACT

Automatically annotating a multimedia content at a base station includes (i) identifying an optimal pairing between a video capturing device and a base station, (ii) receiving, from a video sensor embedded in the video capturing device that captures a video associated with a user, a video sensor data based on the optimal pairing, (iii) receiving, from the video capturing device, a set of information associated with the video capturing device, (iv) synchronizing the video and the video sensor data to obtain a synchronized video content using a transmitted signal power from the video capturing device and a received signal power at the base station, and (v) annotating the synchronized video content with the set of information to obtain an annotated video content.

### BACKGROUND

1. Technical Field

The embodiments herein generally relate to video production systems, and, more particularly, to automatically generating notes and annotating multimedia content specific to a video production.

2. Description of the Related Art

Multi-camera shoots are hard to manage, and with more sophisticated technology can lead to a decrease in productivity in a field. Camera operators need to change batteries and/or change flash memory cards more often and at unpredictable times, thereby interrupting shoots and missing important moments and/or schedules. The problem is amplified with more camera operators on the shoot. As video images get larger with higher resolution with HD, 2K and 4K cameras, data storage and power requirements increase, as do the times required to transfer and process the data. This further requires assistants on a production team to process data from flash cards by dumping the data to field hard drives, synchronizing video and sound files, and processing the data into an appropriate format for an editor and/or a director. Eventually these data assets are copied again to larger storage devices (such as hard drives). Much information is lost in the process with hand written notes on papers, notebooks and on flash cards and drives. Accordingly, there remains a need to effectively transfer the data, and store the data for further processing and annotation.

### SUMMARY

In view of the foregoing, an embodiment herein provides a method for automatically annotating a multimedia content at a base station is provided. The method includes identifying an optimal pairing between a video capturing device and the base station. A video sensor data is received by a processor from a video sensor embedded in the video capturing device that captures a video associated with a user based on the optimal pairing. The video sensor data includes a time series of location data, direction data, orientation data, and a position of the user. A set of information associated with the video capturing device is received. The set of information includes at least one of a current memory level, a current power level, a range data, a location data, an orientation data, lighting, and or identifier. The video and the video sensor data is synchronized to obtain a synchronized video content based on (i) a transmitted signal power from the video capturing device, and (ii) a received signal power at the base station. The synchronized video content is annotated with the set of information to obtain an annotated video content.

A radiation pattern associated with the video capturing device and a sensitivity pattern associated with the base station may be recorded. The radiation pattern and the sensitivity pattern may be beam-like, lobe-like or spherical. A comparison between the annotated video content and production data obtained from a production data server may be performed, and automatically generating recommended digital notes based on the comparison. At least one user suggested digital note from a user may be received. The annotated video content may be associated with the at least one user suggested digital notes. The production data may be selected from the group including of a script, scenes, characters, camera operators, a shoot schedule, call times, digital notes, background information and research notes.

An acknowledgement may be transmitted from the base station to the video capturing device when the video, the video sensor data, and the set of information are received at the base station. At least one of the video, the video sensor data, or the set of information may be erased from a memory of the video capturing device based on the acknowledgement. The method may further comprise recording a radiation pattern associated with the base station and a sensitivity pattern associated with the video capturing device, wherein the radiation pattern and the sensitivity pattern are beam-like, lobe-like, or spherical. The method may further comprise localizing the video capturing device in an environment or with respect to the base station based on the radiation pattern of the base station and the sensitivity pattern of the video capturing device. The method may further comprise identifying the radiation pattern of the base station based on a signal receiving power, the location data, and the orientation data obtained from the video capturing device from at least one location.

In another embodiment, a method for automatically annotating multimedia content obtained from at least one video capturing device including a first video capturing device and a second capturing device at a base station is provided. A first optimal pairing between the base station and the first video capturing device is selected. A first set of information associated with the first video capturing device is received based on the first optimal pairing. The first set of information includes at least one of a current memory level, a current power level, a range data, a location data, an orientation data, lighting, and an identifier. A second optimal pairing between the base station and the second video capturing device is selected. A second set of information associated with the second video capturing device is received based on the second optimal pairing. The second set of information includes at least one of a current memory level, a current power level, a range data, a location data, an orientation data, lighting, and an identifier. The first video capturing device or the second video capturing device is selected based on the first set of information and the second set of information to obtain a selected video capturing device and a selected set of information;

A video sensor data is obtained from a video sensor embedded in the selected video capturing device that captures a video associated with a user. The video sensor data including a time series of location data, direction data, orientation data, and a position of the user. The video and the video sensor data is synchronized to obtain a synchronized video content using (i) the first optimal pairing when the selected video capturing device is the first video capturing device, or (ii) the second optimal pairing when the selected video capturing device is the second video capturing device. The synchronized video content is annotated with the selected set of information to obtain an annotated video content. The first set of information may comprise at least one of the radiation pattern associated with the first video capturing device, and the sensitivity pattern associated with the base station, and wherein the radiation pattern and the sensitivity pattern are beam-like, lobe-like, or spherical. The second set of information may comprise at least one of the radiation pattern associated with the second video capturing device, and the sensitivity pattern associated with the base station, and wherein the radiation pattern and the sensitivity pattern are beam-like, lobe-like, or spherical.

A comparison between the annotated video content and production data obtained from a production data server may be performed. Recommended digital notes may be generated automatically based on the comparison. An acknowledgement may be transmitted from the base station to the selected video capturing device when the video, the video sensor data, and the selected set of information are received at the base station. At least one of the video, the video sensor data, and the selected set of information may be automatically erased from a memory of the selected video capturing device based on the acknowledgement.

In yet another embodiment a base station for automatically annotating multimedia content obtained from an at least one video capturing device including a first video capturing device and a second capturing device is provided. The base station including a memory that stores instructions, a database, and a processor executed by the instructions. An optimal pair selection module which when executed by the processor selects (i) a first optimal pairing between the base station and the first video capturing device, and (ii) a second optimal pairing between the base station and the second video capturing device. A video capturing device information receiving module when executed by the processor, receives a first set of information from the first video capturing device based on the first optimal pairing and a second set of information from the second video capturing device based on the second optimal pairing. The first set of information is selected from the group including of a current memory level, a current power level, a range data, a location data, an orientation data, lighting, and an identifier specific to the first video capturing device. The second set of information is selected from the group including of a current memory level, a current power level, a range data, a location data, an orientation data, lighting, and an identifier specific to the second video capturing device.

A device selection module when executed by the processor selects the first video capturing device or the second video capturing device based on the first set of information and the second set of information to obtain a selected video capturing device and a selected set of information. A sensor data obtaining module when executed by the processor obtains from a video sensor embedded in the selected video capturing device that captures a video associated with a user, a video sensor data including a time series of location data, direction data, orientation data, and a position of the user. A synchronization module when executed by the processor, synchronizes the video and the video sensor data to obtain a synchronized video content using (i) the first optimal pairing when the selected video capturing device is the first video capturing device, or (ii) the second optimal pairing when the selected video capturing device is the second video capturing device. An annotation module when executed by the processor annotates the synchronized video content with the selected set of information to obtain an annotated video content.

The first set of information may comprise at least one of the radiation pattern associated with the first video capturing device, and the sensitivity pattern associated with the base station, and wherein the radiation pattern and the sensitivity pattern are beam-like, lobe-like, or spherical. The second set of information may comprise at least one of the radiation pattern associated with the second video capturing device, and the sensitivity pattern associated with the base station, and wherein the radiation pattern and the sensitivity pattern are beam-like, lobe-like, or spherical.

A comparison module when executed by the processor may perform a comparison of the annotated video content and production data obtained from a production data server. A digital notes generation module when executed by the processor may automatically generate recommended digital notes based on the comparison. At least one user suggested digital notes may be received from a user, and the annotated video content may be associated with the at least one user suggested digital notes instead of the recommended digital notes. An audio capturing device information obtaining module that obtains an audio from an audio capturing device. The sensor data obtaining module obtains an audio sensor data from an audio sensor coupled to the audio capturing device. The audio may be specific to the user. The synchronization module when executed by the processor may further synchronize the video, the video sensor data, the audio, the audio sensor data, and the production data to obtain the synchronized video content.

A self-learning module when executed by the processor may learn a pattern of annotating video content, and generate recommended digital notes based on at least one of the synchronized video content, the at least one user suggested digital notes, the recommended digital notes, and previously annotated video content. A communication module when executed by the processor may transmit an acknowledgement from the base station to the selected video capturing device when the video, the video sensor data, and the selected set of information are received at the base station. At least one of the video, the video sensor data, and the selected set of information is automatically erased from a memory of the selected video capturing device based on the acknowledgement.

The optimal pairing selection module when executed by the processor (i) focuses a radiation pattern of the first video capturing device, (ii) orients the base station to receive a signal from the first video capturing device, (iii) monitors the signal from the first video capturing device to determine an optimal power of the signal, and (iii) selects the first optimal pair between the base station and the first video capturing device corresponding to the optimal power of the signal. The optimal pairing selection module when executed by the processor (i) focuses a radiation pattern of the second video capturing device, (ii) orients the base station to receive a signal from the second video capturing device, (iii) monitors the signal from the second video capturing device to determine an optimal power of the signal, and (iv) selects the second optimal pair between the base station and the second video capturing device corresponding to the optimal power of the signal.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 illustrates a system showing a user being recorded by a first video capturing device and a second video capturing device to annotate and generate digital notes for multimedia content specific to a video production using a base station in communication with a production data server, according to an embodiment herein;

FIG. 2 illustrates an exploded view of the base station of FIG. 1 including a database according to an embodiment herein;

FIG. 3A illustrates production data stored in a database of the production data server of FIG. 1 according to an embodiment herein;

FIG. 3B illustrates a table view of a sensor data, user data, and a first set of information obtained from a first video capturing device and stored in the database of FIG. 2 of the base station of FIG. 1 according to an embodiment herein;

FIG. 4 illustrates a table view of data obtained from one or more video capturing devices that is stored in the database of the base station of FIG. 1 according to an embodiment herein;

FIG. 5 illustrates a schematic diagram of a video capturing device used in accordance with the embodiments herein;

FIG. 6 illustrates a schematic diagram of the base station of FIG. 1 used in accordance with the embodiments herein;

FIG. 7 is a computer system used in accordance with the embodiments herein;

FIG. 8 illustrates an exploded view of the computing device of FIG. 1 used in accordance with the embodiments herein; and

FIG. 9 is a flow diagram illustrating a method for automatically annotating a multimedia content at the base station of FIG. 1 according to an embodiment herein; and

FIG. 10 is a flow diagram illustrating a method for automatically annotating a multimedia content obtained from at least one video capturing device including a first video capturing device and a second capturing device at the base station of FIG. 1 according to an embodiment herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

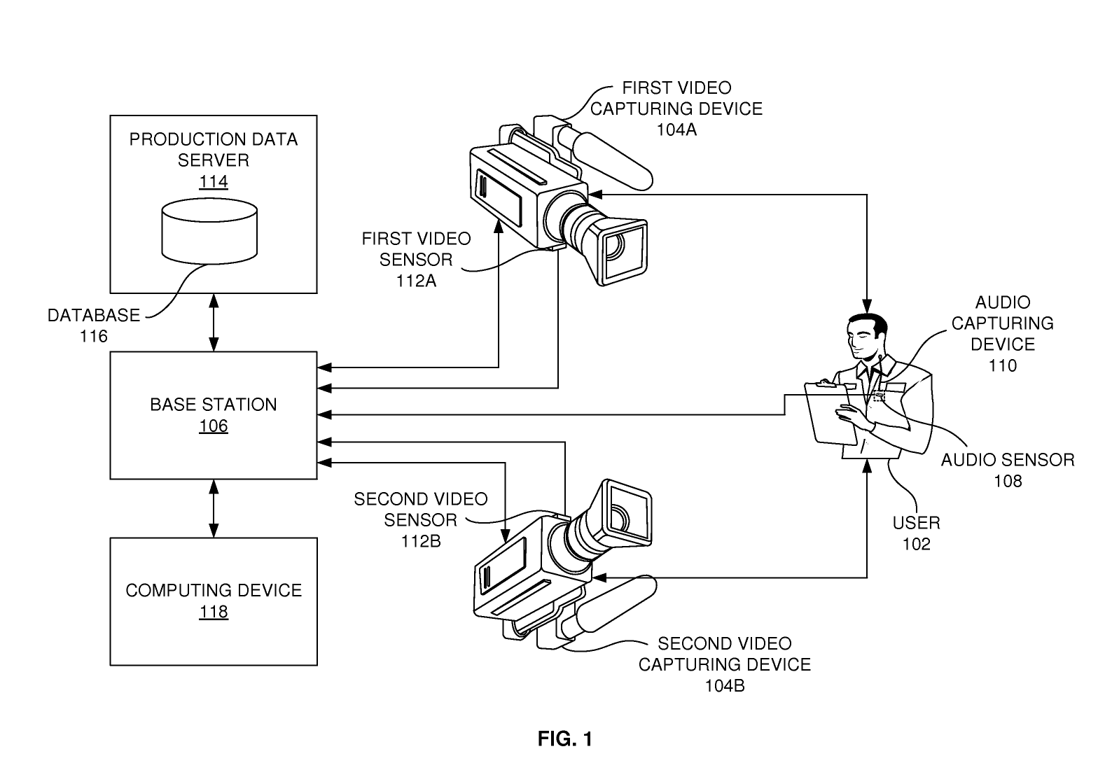

As mentioned, there remains a need to effectively transfer and store data captured during video shoots for further processing and annotation. The embodiments herein achieve this by providing a system which identifies a first optimal pairing and a second optimal pairing between a base station and at least one video capturing device for the video capturing device to communicate optimally with the base station. A video sensor is embedded in the video capturing device that captures a video associated with a user. A video sensor data and a set of information are obtained from the video capturing device. The video and the video sensor data are synchronized to obtain a synchronized multimedia content using the first optimal pairing and/or the second optimal pairing. The synchronized multimedia content with the set of information is annotated to obtain an annotated multimedia content. Referring now to the drawings, and more particularly to FIGS. 1 through 10, where similar reference characters denote corresponding features consistently throughout the figures, there are shown preferred embodiments. An optimal pairing implies parameters that are necessary for a video capturing device to communicate optimally with a base station. Examples of the parameters include, but not limited to, radiation patterns of the video capturing device and/or the base station, antenna orientation at the base station, RF modality, and communication protocol, etc.

FIG. 1 illustrates a system 100 showing a user 102 being recorded by a first video capturing device 104A and a second video capturing device 104B to annotate and generate digital notes for multimedia content specific to a video production using a base station 106 in communication with a production data server 114 according to an embodiment herein. The system 100 further includes an audio sensor 108 coupled to an audio capturing device 110 attached to the user 102, a first video sensor 112A embedded in the first video capturing device 104A, a second video sensor 112B embedded in the second video capturing device 104B, and the production data server 114 that includes a database 116. In one embodiment, the video capturing device 104A-B may be an eyewear device, (e.g., Google glass) worn by a user in a production team. In another embodiment, the video capturing device 104A-B may be operated by a production assistant who is roaming the set and adding more annotations. In one embodiment, a video stream from the production assistant may not be part of a film, but otherwise a highly relevant source of notes. The system further includes a computing device 118 associated with a production team (not shown in FIG. 1).

The user 102 may either be interacting with an audience (not shown in FIG. 1) or with another user (not shown in FIG. 1) in an event or an activity. The event or the activity may include, but is not limited to, a scene being shot for a movie, a television show, and/or a sporting event, a video game, an advertisement, a seminar, an act, a drama, etc. A first optimal pairing is identified between the first video capturing device 104A and the base station 106. Likewise, a second optimal pairing is identified between the second video capturing device 104B and the base station 106. In one embodiment, the first optimal pairing is a function of the radiation patterns of the transmitters involved. For example, a radiation pattern may be beam-like, lobe-like or spherical. In one embodiment, the second optimal pairing is a function of the radiation patterns of the transmitters involved. For example, the radiation patterns associated with said second optimal pairing may be beam-like, lobe-like or spherical, and different from the radiation patterns associated with the first optimal pairing. The first optimal pairing and second optimal pairing can also be a function of the sensitivity patterns of receivers involved. In one embodiment, a sensitivity pattern is based on how a receiver is sensitive to an incoming radiation from different directions. The radiation pattern of the transmitter and the sensitivity pattern of the receiver are combined to obtain a resulting signal. In one embodiment, if the sensitivity pattern of the receiver is omni-directional or circular then an orientation of the receiver is disregarded. Similarly, if the receiver is more sensitive in certain directions then the sensitivity pattern may be lobe-shaped.

In one embodiment the radiation patterns are lobe-like and cover an environment. For example, given a reading at a particular location, a receiver measures a radiation signature at that location. In one embodiment, a set of transmitters time-multiplexes to ensure that no pair of transmitters broadcasts simultaneously. Then, the radiation pattern is unambiguously decomposed into its constituent parts for each transmitter. In another embodiment, since a map of the radiation patterns is known, it is possible for the receiver to know the location from within a bounded set of possibilities. In one embodiment, the map of the radiation patterns is acquired by surveying the environment and training the system.

For example, the surveying the environment and training the system may be performed by walking around a building with a laptop and recording observed signal intensities of the building's unmodified base stations. This data may be used to train the localizer to localize a user to precise, correct location across the entire building. This methodology is described in a paper “Practical robust localization over large-scale 802.11 wireless networks” published in “Proceeding MobiCom '04 Proceedings of the 10th annual international conference on Mobile computing and networking”, the complete disclosure of which, in its entirety, is herein incorporated by reference.

In one embodiment, the radiation pattern and the sensitivity pattern are used to produce one or more orientation estimates. For example, a localization information and an orientation information may then be used to annotate the multimedia content. The first video capturing device 104A transmits a first set of information associated with the first video capturing device 104A through the first optimal pairing. The first set of information may include, but is not limited to, a current memory level, a current power level, a range data, a location data, an orientation data, lighting, and an identifier, in one example embodiment. Likewise, the second video capturing device 104B transmits a second set of information associated with the second video capturing device 104B through the second optimal pairing.

Attributes of the radiation patterns and the sensitivity patterns are added to the sensor data from the remote camera to provide a richer data set in order to understand the meaning of the data being captured. In one embodiment, the attributes of the radiation pattern may be added by the remote camera. In another embodiment, the receiver at the base station may add a sensitivity pattern, especially if this pattern is not constant in time due to different modes of operation for the base station.

In one embodiment, the process of forming the radiation pattern and the sensitivity pattern helps to obtain location related information, which becomes even more useful in a noisy wireless environment. In one embodiment, if there are multiple devices, a known beacon, or any other constraints on geometry, then a triangulation is performed to know a precise location, including while indoors, without global positioning system (GPS) information. Based on the attenuation in signal power as a function of distance, a signal data may enable pinpointing a location or relative position. In one embodiment, the video signal is annotated with data that can be translated into more meaningful notes based on one or more geometries of a plurality of devices. In one embodiment, the one or more geometries of the plurality of devices is identified based on directional wireless transmission.

The second set of information may include, but is not limited to, a current memory level, a current power level, a range data, a location data, an orientation data, lighting, and an identifier, in one example embodiment. The first optimal pairing and the second optimal pairing may be refined to obtain refined optimal pairings based on learnings from past patterns by the base station 106. The past patterns, the location data and the orientation data may be obtained from the first video capturing device 104A and the second video capturing device 104B. The refined optimal pairings enable faster data transmission between the first video capturing device 104A, the second video capturing device 104B, and the base station 106. In one embodiment, the pattern matching of camera and the sensor data is associated with other information through a learning process in which the user trains the system by reviewing and correcting suggestions made by the system.

Based on the first set of information and the second set of information, the base station 106 prioritizes the first video capturing device 104A or the second video capturing device 104B. For example, when the current memory level of the first video capturing device 104A is lower than the current memory level of the second video capturing device 104B, the base station 106 prioritizes the first video capturing device 104A instead of the second video capturing device 104B. The first video capturing device 104A captures a first video associated with the user 102 and transmits the first video to the base station 106. Similarly, the second video capturing device 104B captures a second video associated with the user 102 and transmits the second video to the base station 106. The second video may be transmitted at a time interval after the first video is transmitted completely. The first video capturing device 104A and the second video capturing device 104B may be configured as any of a video camera, a digital camera, a camcorder, a mobile communication device, in one example embodiment. It is to be understood that the system may be implemented with only one video capturing device. As way of clarity and for better understanding of the embodiments described herein, two video capturing devices are illustrated. The system 100 may further include additional video capturing devices to capture video from multiple angles in other embodiments. The system may further include a boom microphone that includes an audio sensor that records audio data associated with the user 102. In a preferred embodiment, the radiation pattern of a video capturing device and the sensitivity pattern of the base station 106 are identified based on a location data and orientation data obtained from the video capturing device. The system 100 localizes a video capturing device in an environment or with respect to the base station 106 based on the radiation pattern of the base station 106 and the sensitivity pattern of the video capturing device. Further, the system 100 identifies the sensitivity pattern of the base station 106 based on a signal receiving power, a location data, and an orientation data obtained from a video capturing device from at least one location. In one embodiment, a radiation pattern associated with a video capturing device and a sensitivity pattern associated with the base station 106 are being recorded.

The audio sensor 108 that is coupled to the audio capturing device 110 captures a user data that may include a time series of the location data, direction data, and orientation data associated with the user 102. The audio capturing device 110 captures an audio. The audio may be specific to (i) the user 102, (ii) another user, (iii) an audience, or (iv) combinations thereof, in example embodiments. The audio capturing device 110 may be configured as any of a microphone and an audio recorder such as tape recorder, etc., in another example embodiment.

The first video sensor 112A embedded in the first video capturing device 104A captures a first video sensor data that may include a time series of the location data, direction data, orientation data, vibration data, sound data, motion data, camera settings data, lens information and a position of the user 102. Similarly, The second video sensor 112B embedded in the second video capturing device 104B may capture a second video sensor data that includes a time series of the location data, direction data, orientation data, vibration data, sound data, motion data, camera settings data, lens information, and a position of the user 102.

The boom microphone is a multi-channel sound recorder used by one or more sound engineers or one or more camera operators to record an audio (for better clarity) associated with the user 102 using the audio sensor. Each of the sensors (e.g., the audio sensor 108, the first video sensor 112A, and the second video sensor 112B) are assigned a unique identifier to (i) identify data aggregated from the audio sensor 108, the first video sensor 112A, and the second video sensor 112B at the base station 106 for annotating multimedia content, in one example embodiment.

The base station 106 comprises one or more of a personal computer, a laptop, a tablet device, a smart phone, a mobile communication device, a personal digital assistant, or any other such computing device, in one example embodiment. The base station 106 (i) receives the first video and the first set of information from the first video capturing device 104A, and the first video sensor data from the first video sensor 112A, (ii) synchronizes the first video and the first video sensor data to obtain a first synchronized data using the first optimal pairing, and the second optimal pairing (iii) annotates the first synchronized data with the first set of information to obtain a first annotated multimedia content. Likewise, the base station 106 receives the second video and the second set of information from the second video capturing device 104B, and the second video sensor data from the second video sensor 112B, (ii) synchronizes the second video and the second video sensor data to obtain a second synchronized data using the first optimal pairing, and the second optimal pairing, (iii) annotates the second synchronized data with the second set of information to obtain a second annotated multimedia content. It is to be understood that the first annotated multimedia content and the second annotated multimedia content may be further annotated with each other.

The base station 106 performs a comparison of the first annotated multimedia content and production data obtained from the database 116 of the production data server 114, and automatically generates recommended digital notes based on the comparison. The recommended digital notes are annotated with the first multimedia content, in one example embodiment. The recommended digital notes are communicated to the computing device 118 associated with the production team for any corrections (or modifications), suggestions, etc., in another example embodiment. The production team comprises any of a producer, a director, a camera operator, and an editor, etc. The production team may either confirm the recommended digital notes, or provide at least one user suggested digital notes through the computing device 118 (or by directly accessing the base station 106). The user suggested digital notes as received from the production team may be associated to (or annotated with) the first annotated multimedia content. Likewise, the base station 106 performs a comparison for the second multimedia content, and similar recommended digital notes are communicated to the production team for corrections (or modification), and/or confirmation, etc. The recommended digital notes may be templates for filling in the blank or multiple choice questions, saving the production team's time in adding detailed notes based on prompts (by the base station 106) on the computing device 118 of the production team. The computing device 118 comprises at least one of a personal computer, a laptop, a tablet device, a smart phone, a mobile communication device, a personal digital assistant, or any other such computing device, in one example embodiment.

The production data may include, but not be limited to, script information (scenes), characters and subjects, locations, camera operators, schedule, call times and information, in one example embodiment. Other similar data may be annotated with the first synchronized data and the second synchronized data. Other data may include but not be limited to, training data and data from other scenes and shoots, etc., in another example embodiment.

The base station 106 learns the pattern of annotating multimedia content, and generates one or more digital notes for the annotated multimedia content based on one or more inputs provided by the production data server 114 and the production team. The base station 106 learns the pattern of annotating multimedia content based on (i) one or more recommended digital notes, (ii) one or more user suggested digital notes, and/or (iii) previously annotated multimedia content. The one or more inputs may be based on the information obtained from the database 116 and a third party data source. The one or more inputs may include a generation of digital notes with specific data patterns, and suggestions to annotate one or more recommended sections. The database 116 stores the production data, and annotation data and associated production data from past shoots and the patterns of annotation data from the past shoots.

When the one or more recommended digital notes are obtained and displayed to the production team and do not correlate with a user's intent or user context of the production team, the user may suggest his/her own user suggested digital notes that can be associated with the annotated multimedia content. In other words, one or more user suggested digital notes are processed from the user and are associated with the annotated multimedia content over the one or more recommended digital notes (that are recommended by the base station 106). The one or more user suggested digital notes are recommended by the user, when the one or more recommended digital notes do not match or correlate with user context (or user intent).

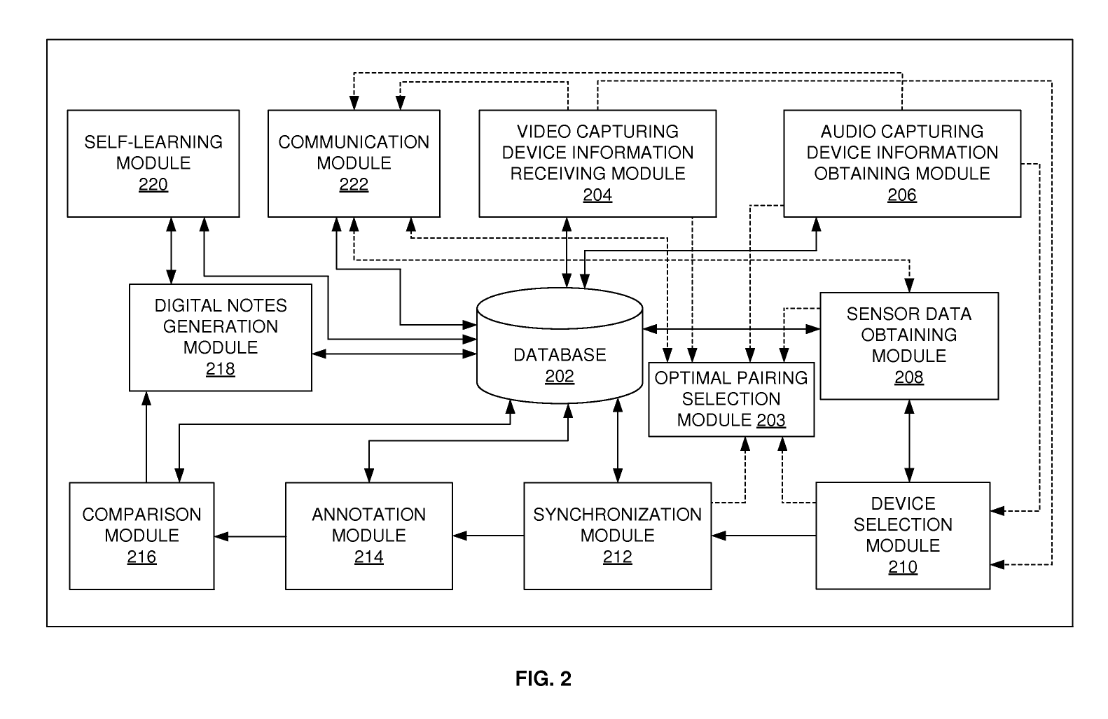

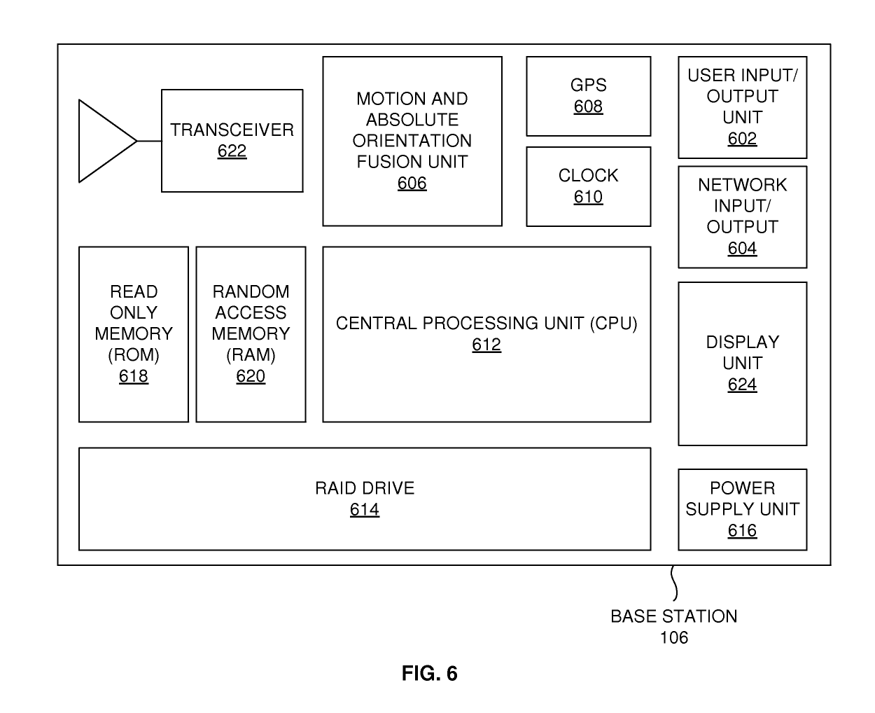

FIG. 2, with reference to FIG. 1, illustrates an exploded view of the base station 106 of FIG. 1 including a database 202 according to an embodiment herein. The base station 106 includes a processor (e.g., a CPU 612 of FIG. 6), a memory (e.g., a raid drive 614, or a read only memory 618, or a random access memory 620 of FIG. 6), a database 202, an optimal pairing selection module 203, a video capturing device information receiving module 204, an audio capturing device information obtaining module 206, a sensor data obtaining module 208, a device selection module 210, a synchronization module 212, an annotation module 214, a comparison module 216, a digital notes generation module 218, a self-learning module 220, and a communication module 222. The memory 614 stores a set of instructions and the database 202. The processor 612 is configured by the set to instructions to execute the optimal pairing selection module 203, the video capturing device information receiving module 204, the audio capturing device information obtaining module 206, the sensor data obtaining module 208, the device selection module 210, the synchronization module 212, the annotation module 214, the comparison module 216, the digital notes generation module 218, the self-learning module 220, and the communication module 222. The database 202 stores data or information obtained by the video capturing device information receiving module 204, the audio capturing device information obtaining module 206, and the sensor data obtaining module 208 from the first video capturing device 104A, the second video capturing device 104B, and the audio capturing device 110. The optimal pairing selection module 203 selects a first optimal pairing between the base station 106 and the first video capturing device 104A. The optimal pairing selection module 203 focuses a radiation pattern of the first video capturing device 104A, and orients the base station 106 to receive a signal from the first video capturing device 104A. The optimal pairing selection module 203 further monitors the signal from the first video capturing device 104A to determine an optimal power of the signal, and selects a first optimal pairing configuration between the base station 106 and the first video capturing device 104A corresponding to the optimal power of the signal.

Similarly, the optimal pairing selection module 203 selects a second optimal pairing between the base station 106 and the second video capturing device 104B. The optimal pairing selection module 203 focuses a radiation pattern of the second video capturing device 104B, and orients the base station 106 to receive a signal from the second video capturing device 104B. The optimal pairing selection module 203 further monitors the signal from the second video capturing device 104B to determine an optimal power of the signal, and selects a second optimal pairing configuration between the base station 106 and the second video capturing device 104B corresponding to the optimal power of the signal. In one embodiment, the first optimal pairing may be selected based on a radiation pattern of a transmitter of the first video capturing device 104A (e.g., a first camera), which can be beam-like, lobe-like, or spherical. In one embodiment, the second optimal pairing may be further selected based on a radiation pattern of a transmitter of the second video capturing device 104B (e.g., a second camera), which can be beam-like, lobe-like, or spherical.

The video capturing device information receiving module 204 receives a first set of information from the first video capturing device 104A based on the first optimal pairing. Similarly, the video capturing device information receiving module 204 obtains a second set of information from the second video capturing device 104B based on the second optimal pairing. In one embodiment, the first set of information is selected from the group including of a current memory level, a current power level, a range data, a location data, an orientation data, lighting, and an identifier specific to the first video capturing device 104A. In one embodiment, the second set of information is selected from the group including of a current memory level, a current power level, a range data, a location data, an orientation data, lighting, and an identifier specific to the second video capturing device 104B. The device selection module 210 selects either the first video capturing device 104A or the second video capturing device 104B to obtain a selected video capturing device and a selected set of information based on the first set of information and the second set of information. Based on the first set of information and the second set of information, the base station 106 prioritizes the first video capturing device 104A or the second video capturing device 104B. For example, when the current memory level of the first video capturing device 104A is lower than the current memory level of the second video capturing device 104B, the base station 106 prioritizes the first video capturing device 104A instead of the second video capturing device 104B. In other words, the base station 106 requests the first video capturing device 104A to transmit data instead of the second video capturing device.

The video capturing device information receiving module 204 obtains the first video associated with the user 102 from the first video capturing device 104A and the first video sensor data from the first video sensor 112A. The first video sensor data includes a time series of the location data, direction data, orientation data, and a position of the user 102. Similarly, the audio capturing device information obtaining module 206 obtains an audio associated with the user 102 from the audio capturing device 110, and an audio sensor data from the audio sensor 108. The audio sensor data includes a time series of the location data, direction data, and orientation data associated with the user 102. The audio may be specific to (i) the user 102, (ii) the another user, (iii) an audience, or (iv) combinations thereof, in example embodiments. The audio capturing device information obtaining module 206 may further obtain an audio, and/or an audio sensor data from a boom microphone if used.

The synchronization module 212 synchronizes the first video and the first video sensor data to obtain a first synchronized data using the first optimal pairing and the second optimal pairing. The synchronization module 212 may further synchronize the first video, the first video sensor data, the audio data, and the audio sensor data to obtain the first synchronized data. The annotation module 214 annotates the first synchronized data with the first set of information to obtain a first annotated multimedia content. Likewise, the video capturing device information receiving module 204 receives the second video and the second set of information from the second video capturing device 104B, and the second video sensor data from the second video sensor 112B. The synchronization module 212 synchronizes the second video and the second video sensor data to obtain a second synchronized data using the first optimal pairing and the second optimal pairing. The synchronization module 212 may further synchronize the second synchronized data with the first synchronized data.

The annotation module 214 annotates the second synchronized data with the second set of information to obtain a second annotated multimedia content. It is to be understood that the first annotated multimedia content and the second annotated multimedia content may be further annotated with each other. In one embodiment, the sensor data obtaining module 208 obtains from a video sensor embedded in the selected video capturing device (e.g., the first video capturing device 104A or the second video capturing device 104B) that captures a video associated with a user, a video sensor data including a time series of location data, direction data, orientation data, and a position of the user 102 based on an optimal pairing. The synchronization module 212 synchronizes the video and the video sensor data to obtain a synchronized video content using (i) the first optimal pairing when the selected video capturing device is the first video capturing device 104A, or (ii) the second optimal pairing when the selected video capturing device is the second video capturing device 104B. In another embodiment, the synchronization module 212 synchronizes the video and the video sensor data to obtain a synchronized video content using a transmitted signal power and a received signal power.

In one embodiment, a transmitted signal includes any information which is transmitted from one or more video capturing devices, one or more audio capturing devices, one or more video sensors, and/or one or more audio sensors to the base station 106. Examples of the transmitted signal include a video associated with a user, a video sensor data, a first set of information, a second set of information, an audio from one or more audio capturing devices, audio sensor data from one or more audio sensors, and/or a radiation pattern. A received signal includes the transmitted signal that is received at the base station 106. In one embodiment, the synchronization module 212 synchronizes a video and a video sensor data of the transmitted signal at the base station 106 using a transmitted signal power (i.e., power at which optimum level of signal transmission occurs from a video capturing device), and a received signal power (i.e., power or strength at the receiving base station 106 of the signal transmitted by the video capturing device), to obtain a synchronized video. The annotation module 214 annotates the synchronized video content with the selected set of information to obtain an annotated video content.

A first order of annotations may be a series of angles and power levels in combination with other data from the camera, including ID, lens information, settings, and lighting as well as accelerometer and orientation data. In one embodiment, the radiation pattern of the video capturing device 104A-B and the sensitivity pattern of the base station 106 of this data may be matched to higher order information by associating with context-specific information such as scene, location, character, page or line of script, identity of shooter, character, etc.

The comparison module 216 performs a comparison of the first annotated multimedia content and production data obtained from the database 116 of the production data server 114. The digital notes generation module 218 automatically generates a first set of recommended digital notes based on the comparison. The first set of recommended digital notes is annotated with the first multimedia content, in one example embodiment. The first set of recommended digital notes is communicated to the computing device 118 associated with the production team for any corrections (or modifications), suggestions, etc. prior to annotating the first set of recommended digital notes with the first annotated multimedia content, in another example embodiment. Likewise, the comparison module 216 performs a comparison of the second annotated multimedia content and production data obtained from the database 116 of the production data server 114, and the digital notes generation module 218 automatically generates a second set of recommended digital notes based on the comparison. Similarly, the second set of recommended digital notes is annotated with the second multimedia content, in one example embodiment. The second set of recommended digital notes is communicated to the computing device 118 associated with the production team for any corrections (or modifications), suggestions, etc. prior to annotating the second set of recommended digital notes with the second annotated multimedia content, in another example embodiment. The production team comprises any of a producer, a director, a camera operator, and an editor, etc. The production team may either confirm the first set and the second set of recommended digital notes, or provide at least one user suggested digital notes. The user suggested digital notes as received from the production team may be associated (or annotated with) the first annotated multimedia content and/or the second annotated multimedia content.

The production data may include, but not limited to, script information (scenes), characters and subjects, locations, camera operators, schedule, call times and information, in one example embodiment. Other similar data may be annotated with the first synchronized data and the second synchronized data. Other data may include but not limited to, training data and data from other scenes and shoots, etc., in another example embodiment.

The self-learning module 220 learns the pattern of annotating multimedia content, generating one or more recommended digital notes for the annotated multimedia content based on one or more inputs provided by the production data server 114 and the production team. The self-learning module 220 learns the pattern of annotating multimedia content based on (i) one or more recommended digital notes, (ii) one or more user suggested digital notes, (iii) previously annotated multimedia content. The one or more inputs may be based on the information obtained from the database 116 and a third party data source. The one or more inputs include a generation of digital notes with specific data patterns, and suggestions to annotate one or more recommended sections.

When the one or more recommended digital notes are obtained and displayed to the production team and do not correlate with a user's intent or user context of the production team, the user may suggest his/her own user suggested digital notes that can be associated with the annotated multimedia content. In other words, one or more user suggested digital notes are processed from the user and are associated with the annotated multimedia content over the one or more recommended digital notes (that are recommended by the base station 106). The one or more user suggested digital notes are recommended by the user, when the one or more recommended digital notes do not match or correlate with user context (or user intent).

The communication module 222 communicates an acknowledgement to the first video capturing device 104A, the second video capturing device 104B, and the audio capturing device 110. Upon receipt of the acknowledgement, the data (e.g., the first video, the second video, the first video sensor data, the second video sensor data) stored (and/or recorded) in the respective devices (e.g., the first video capturing device 104A, the second video capturing device 104B, and the audio capturing device 110) are automatically erased (or cleared, or deleted).

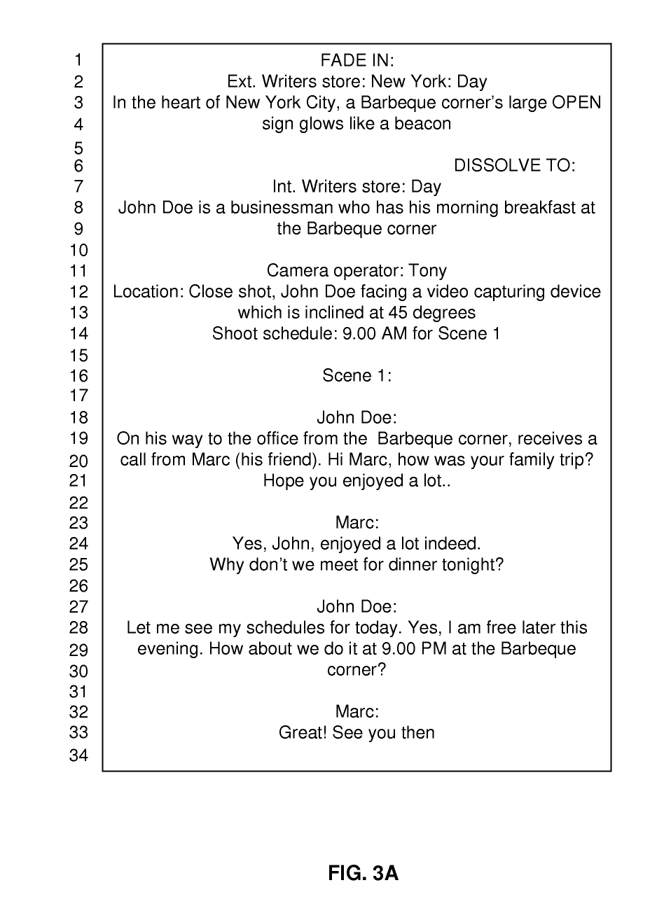

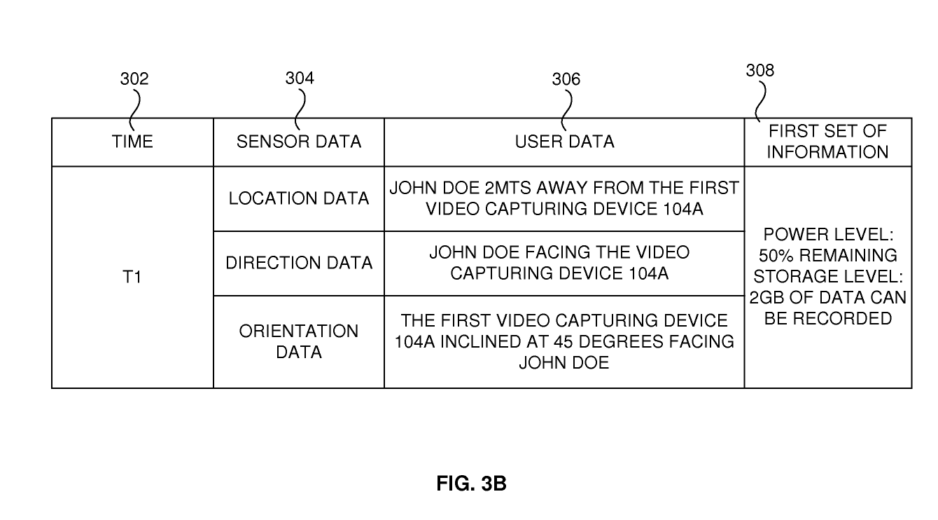

FIG. 3A, with reference to FIGS. 1 and 2, illustrates the production data stored in the database 116 of the production data server 114 of FIG. 1 according to an embodiment herein. The lines 3-4 represent the background information from the production data. The lines 8-9 represent an introduction of the user 102 as a first character (e.g., a businessman), and an actor (e.g., John Doe) playing the first character. Similarly, line 11 represents a camera operator name (e.g., Tony operating at least one of the first video capturing device 104A or the second video capturing device 104B). Lines 12-14 from the production data represent a shoot schedule and/or call times, for a particular scene. For example, the shoot schedule and the call times represent 9.00 AM for Scene 1. Lines 16-33 represent dialogues from a script to be delivered by the first character (e.g., John Doe) and a second character (e.g., Marc). The script may be related, but not limited to, any of activity such as a TV show, a scene in a movie. In one embodiment, the production data is stored in XML or a similar markup language format.

FIG. 3B, with reference to FIGS. 1 through 3A, illustrates a table view of a sensor data, user data, and the first set of information obtained from the first video capturing device 104A and stored in the database 202 of FIG. 2 of the base station 106 of FIG. 1 according to an embodiment herein. Although, FIG. 3B depicts the table view of the sensor data, user data, and the first set of information obtained from the first video capturing device 104A and stored in the database 202 of FIG. 2, it is to be understood that the database 202 also stores similar information obtained from other video capturing devices (e.g., the second video capturing device 104B), audio capturing devices (e.g., the audio capturing device 110), and sensors (e.g., the first video sensor 112A, the second video sensor 112B, and the audio sensor 108) embedded/or coupled to these video capturing devices, and audio capturing devices. The database 202 includes a time field 302, a sensor data field 304, a user data field 306, and a first set of information field 308. The time field 302 includes a series of time intervals (e.g., T1, T2 . . . T_{N}) at which a shoot for a scene is scheduled (e.g., 9.00 AM). In one embodiment, the time intervals occur at one or more regular intervals. In another embodiment, the time intervals are regularly spaced and denote scene transition times. The sensor data field 304 includes one or more time series of location data, direction data, and/or orientation data. The user data field 306 includes data obtained from at least one of the first video, the second video, the first video sensor data, the second video sensor data, and/or the audio sensor data. For example, the user data “John Doe is 2 mts away from the first video capturing device 104A” corresponds (or is specific) to the location data. Similarly, the user data “John Doe facing the first video capturing device 104A” corresponds (or is specific) to the direction data. Likewise, the user data “the first video capturing device 104A is inclined at 45 degrees facing John Doe” corresponds (or is specific) to the orientation data and the lines 12-13 from the production data of FIG. 3A. The first set of information field 308 includes the first set of information such as power level: 50% remaining, storage level: 2 Giga Bytes of data can be recorded (or stored) associated with the first video capturing device 104A.

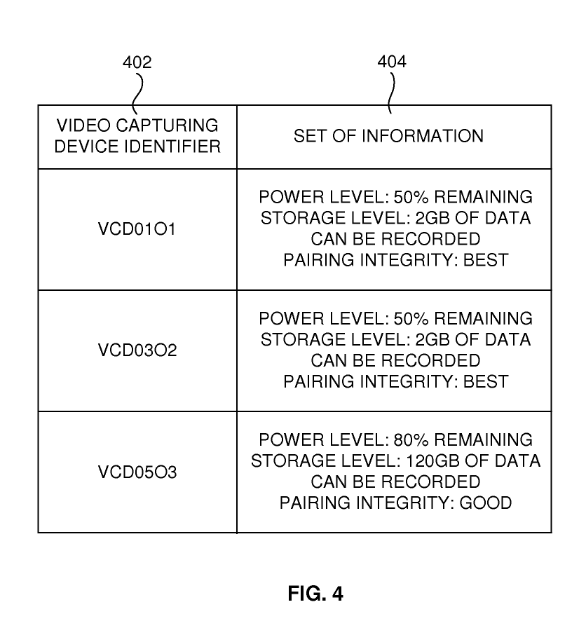

FIG. 4, with reference to FIGS. 1 through 3B, illustrates a table view of data obtained from one or more video capturing devices that is stored in the database 202 of the base station 106 of FIG. 1 according to an embodiment herein. The database 202 includes a video capturing device identifier field 402, and a set of information field 404. The video capturing device identifier field 402 includes a video identifier that is specific to a particular video capturing device. For example, a first video capturing device identifier VCD01O1 is specific to the first video capturing device 104A. Similarly, a second video capturing device identifier VCD03O2 is specific to the second video capturing device 104B. Likewise, a third video capturing device identifier VCD05O3 is specific to a third video capturing device (not shown in FIG. 1 through 4). The set of information field 404 includes a first set of information obtained from the first video capturing device 104A, a second set of information obtained from the second video capturing device 104B, and a third set of information obtained from the third video capturing device (not shown in FIGS). For example, the first set of information includes a power level: 50% remaining, a storage level: 2 GB of data can be recorded (or stored), and a pairing integrity data: best, that are specific to the first video device identifier associated with the first video capturing device 104A. Similarly, the second set of information includes a power level: 50% remaining, a storage level: 2 GB of data can be recorded (or stored), and a pairing integrity data: best, that are specific to the second video device identifier associated with the second video capturing device 104B. Likewise, the third set of information includes a power level: 80% remaining, a storage level: 120 GB of data can be recorded (or stored), a pairing integrity data: good, that are specific to the third video device identifier associated with the third video capturing device. In one embodiment, the radiation pattern of the transmitter and the sensitivity pattern of the receiver are both recorded when both the transmitter and the receiver are directional. Similarly, the database 202 may store one or more audio identifiers specific one or more audio capturing devices. For example, the database 202 may store an audio device identifier ACD0101 that is specific to the audio capturing device 110.

An update associated with the first set of information, the second set of information, and the third set of information may be obtained from the first video capturing device 104A, the second video capturing device 104B, and the third video capturing device in real time (or near real time), in one example embodiment. An update associated with the first set of information, the second set of information, and the third set of information may be obtained from the first video capturing device 104A, the second video capturing device 104B, and the third video capturing device is offline (e.g., when there is no shoot scheduled), in another example embodiment.

Based on the first set of information, the second set of information, and the third set of information, the device selection module 210 selects the first video capturing device 104A to transmit the data (e.g., the first video, the first video sensor data) instead of the second video capturing device 104B and the third video capturing device, in one example embodiment. Similarly, the device selection module 210 may select the second video capturing device 104B to transmit the data (e.g., the second video, the second video sensor data) instead of the first video capturing device 104A and the third video capturing device, in one example embodiment. In one embodiment, the device selection module 210 may prioritize either the first video capturing device 104A or the second video capturing device 104B instead of the third video capturing device because pairing with the base station 106 is better for the first video capturing device 104A and the second video capturing device 104B, as compared to the pairing associated with the third video capturing device. Thus, the base station 106 performs prioritization of bandwidth based on available memory, power, and director prioritization of remote video capturing device.

Alternatively, the base station 106 may also prompt the production team to select at least one of a video capturing device from the first video capturing device 104A, the second video capturing device 104B, and the third video capturing device for data transmission. The base station 106 may prompt the production team to select through the computing device 118 associated with the production team.

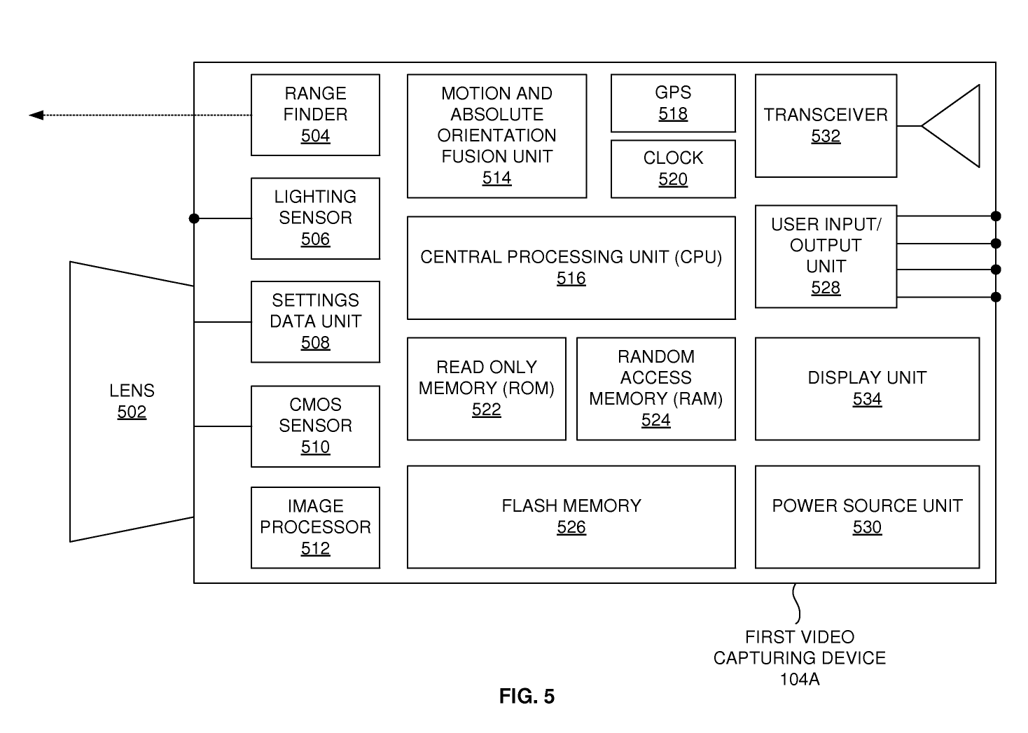

FIG. 5, with reference to FIGS. 1 through 4, illustrates a schematic diagram of a video capturing device used in accordance with the embodiments herein. The video capturing device (e.g., the first video capturing device 104A, the second video capturing device 104B, and the third video capturing device) includes a lens 502, a range finder 504, a lighting sensor 506, a settings data unit 508, a CMOS sensor 510, an image processor 512, a motion and absolute orientation fusion unit 514, a central processing unit 516, a global positioning system (GPS) 518, a clock 520, a read only memory 522, a random access memory 524, a flash memory 526, a user input/output unit 528, a power source unit 530, a transceiver 532, and a display unit 534. The lens 502 includes a piece of glass or other transparent material with curved sides for concentrating or dispersing light rays, used singly (as in a magnifying glass) or with other lenses (as in a telescope). The range finder 504 computes a distance between the video capturing device 104A, 104B and the user 102. The lighting sensor 506 detects an amount of light during when a scene is shot (or when a video is being recorded). The settings data unit 508 determines a set of information that includes, but not limited to, a power level, a storage level, an orientation data, a location data, the pattern formation data, etc. and transmits to the base station 106.

The CMOS sensor 510 (also referred as an image sensor) which includes an integrated circuit containing an array of pixel sensors, each pixel containing a photo detector and an active amplifier to capturing high quality images (or series of frames), and/or videos. The image processor 512 processes the high quality images (or series of frames), and/or videos captured by the image sensor. The motion and absolute orientation fusion unit 514 may include a 3-axis gyroscope, a 3-axis accelerometer, and a 3-axis geomagnetic sensor. Each of these sensors exhibits inherent strengths and weaknesses with respect to motion-tracking and absolute orientation associated with a video recording of the user 102. Each of these sensors are further configured to calculate precise measurement of movement, direction, angular rate, and acceleration in three perpendicular axes.

The central processing unit 516 may be embodied as a micro-controller that is configured to execute instructions stored in a memory (e.g., the read only memory 522, the random access memory 524, and the flash memory 526) including, but not limited to, an operating system, sensor I/O procedures, sensor fusion procedures for combining raw orientation data from multiple degrees of freedom in the orientation sensors to calculate absolute orientation, transceiver procedures for communicating with a receiver unit and determining for communications accuracy, power procedures for going into power saving modes, data aggregation procedures for collecting and transmitting data in batches according to a duty cycle, and other applications. The GPS 518 is configured to establish absolute location of the sensor, and may be made more precise through triangulation of Wi-Fi or beacon signals at known locations.

The clock 520 tracks absolute time so that all data streams (e.g., data feeds that are being recorded such as time series of data) are synchronized and may be reset by a beacon signal or from the GPS 518 or other wireless signal. The user input/output unit 528 enables the production team to provide additional measured features of the user 102 (e.g., heart rate, heart rate variability, blood pressure, respiration, perspiration, etc.) or the environment (e.g., temperature, barometric pressure, moisture or humidity, light, wind, presence of chemicals, etc.). The power source unit 530 may include, but not limited to, a battery, solar cells, and/or an external power supply to power the video capturing device. The transceiver 532 may include an antenna and is configured to transmit collected data and sensor node identification to the base station 106 and may receive a beacon signal to synchronize timing with other sensor nodes, or to indicate standby or active modes of operation. The display unit 534 is configured to display data that includes, but not limited to, information associated with the production team, a video being recorded, and settings data associated with the video capturing device, etc.

FIG. 6, with reference to FIGS. 1 through 5, illustrates a schematic diagram of the base station 106 of FIG. 1 used in accordance with the embodiments herein. The base station 106 includes a user input/output unit 602, a network input/output unit 604, a motion and absolute orientation fusion unit 606, a global position system (GPS) 608, a clock 610, a central processing unit 612, a raid drive 614, a power supply unit 616, a read only memory (ROM) 618, a random access memory (RAM) 620, a transceiver 622, and a display unit 624. The user input/output unit 602 enables the production team to provide additional measured features of the user 102 (e.g., heart rate, heart rate variability, blood pressure, respiration, perspiration, etc.) or the environment (e.g., temperature, barometric pressure, moisture or humidity, light, wind, presence of chemicals, etc.), in one example embodiment. The network input/output unit 604 enables the base station 106 to receive one or more inputs from one or more external connected devices such as third party resources, etc., and process these inputs to produce one or more outputs and communicate with the external connected devices through a network.

The motion and absolute orientation fusion unit 606 may include a 3-axis gyroscope, a 3-axis accelerometer, and a 3-axis geomagnetic sensor. Each of these sensors exhibits inherent strengths and weaknesses with respect to motion-tracking and absolute orientation associated with a video recording of the user 102. Each of these sensors are further configured to calculate precise measurement of movement, direction, angular rate, and acceleration in three perpendicular axes.

The global positioning system (GPS) 608 is configured to establish absolute location of the sensor, and may be made more precise through triangulation of Wi-Fi or beacon signals at known locations. The clock 610 tracks absolute time so that all data streams (e.g., data feeds that are being recorded such as time series of data) are synchronized and may be reset by a beacon signal or from the GPS 608 or other wireless signal. The central processing unit 612 may be embodied as a micro-controller that is configured to execute instructions stored in a memory (e.g., the read only memory 618, the random access memory 620) including, but not limited to, an operating system, sensor I/O procedures, sensor fusion procedures for combining raw orientation data from multiple degrees of freedom in the orientation sensors to calculate absolute orientation, transceiver procedures for communicating with a receiver unit and determining for communications accuracy, power procedures for going into power saving modes, data aggregation procedures for collecting and transmitting data in batches according to a duty cycle, and other applications.

The raid (Redundant Array of Inexpensive Disks) drive 614 is a technology that allows computer users to achieve high levels of storage reliability from low-cost and less reliable PC-class disk-drives. The raid drive 614 combines multiple disk drive components into a logical unit for the purposes of data redundancy and performance improvement. The power supply unit 616 may include, but not limited to, a battery, solar cells, and/or an external power supply to power the base station 106.

The transceiver 622 may include an antenna and is configured to transmit collected data and sensor node identification to one or more devices such as (i) the first video capturing device 104A, (ii) the second video capturing device 104B, (iii) the audio sensor 108, (iv) the audio capturing device 110, (v) the first video sensor 112A, and/or (vi) the second video sensor 112B and may receive a beacon signal from the one or more devices to synchronize timing with other sensor nodes, or to indicate standby or active modes of operation. The display unit 624 is configured to display data that includes, but not limited to, information associated with the production team, a video being recorded, and settings data associated with the video capturing device, etc.

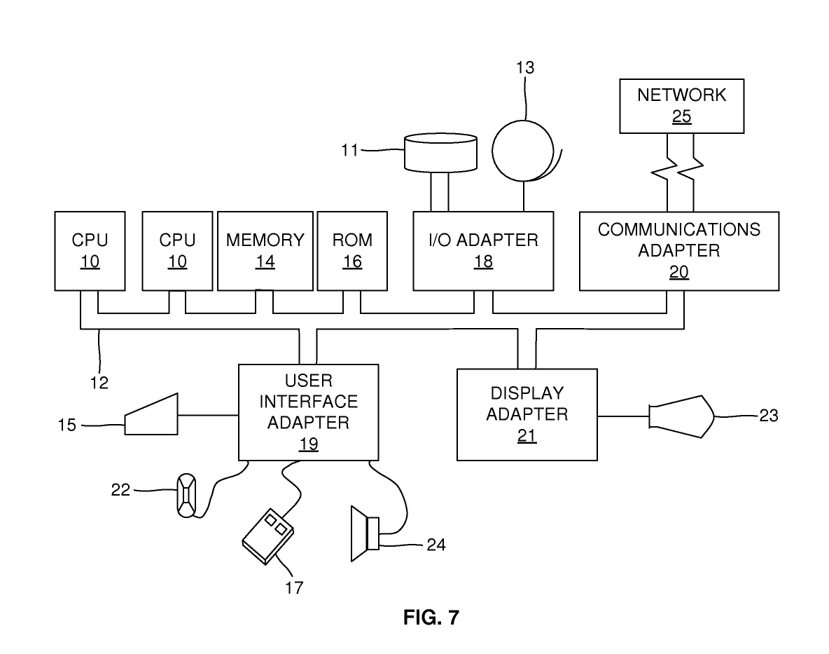

FIG. 7, with reference to FIGS. 1 through 6, is a computer system used in accordance with the embodiments herein. The computer system is the data production server 114, in one example embodiment. The computer system is the base station 106, in another example embodiment. This schematic drawing illustrates a hardware configuration of an information handling/computer system in accordance with the embodiments herein. The system comprises at least one processor or central processing unit (CPU) 10. The CPUs 10 are interconnected via system bus 12 to various devices such as a memory 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments herein. The CPU 10 is the same central processing unit 516 when the computer system is the data production server 114. The CPU 10 is the same central processing unit 612 when the computer system is the base station 106.

The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The embodiments herein can include hardware and software embodiments. The embodiments that comprise software include but are not limited to, firmware, resident software, microcode, etc.

Furthermore, the embodiments herein can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

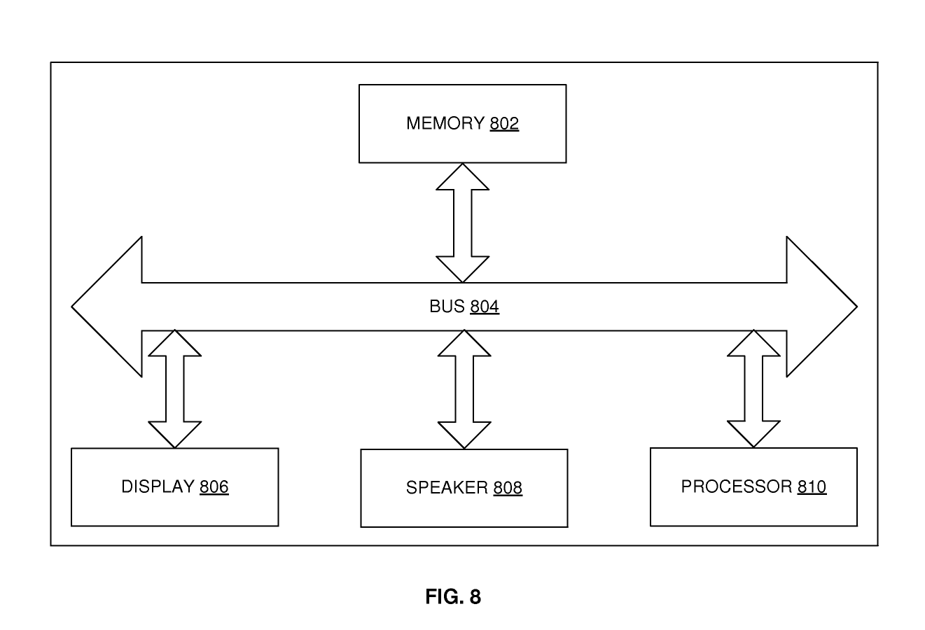

FIG. 8 illustrates an exploded view of the computing device 118 of FIG. 1 having a memory 802 having a set of computer instructions, a bus 804, a display 806, a speaker 808, and a processor 810 capable of processing the set of computer instructions to perform any one or more of the methodologies herein, according to an embodiment herein. The processor 810 may also enable digital content to be consumed in the form of video for output via one or more displays 806 or audio for output via speaker and/or earphones 808. The processor 810 may also carry out the methods described herein and in accordance with the embodiments herein.

Digital content may also be stored in the memory 802 for future processing or consumption. The memory 802 may also store program specific information and/or service information (PSI/SI), including information about digital content (e.g., the detected information bits) available in the future or stored from the past. A user (e.g., the production team) of the computing device 118 may view this stored information on display 806 and select an item of for viewing, listening, or other uses via input, which may take the form of keypad, scroll, or other input device(s) or combinations thereof. When digital content is selected, the processor 810 may pass information. The content and PSI/SI may be passed among functions within the computing device 118 using the bus 804.

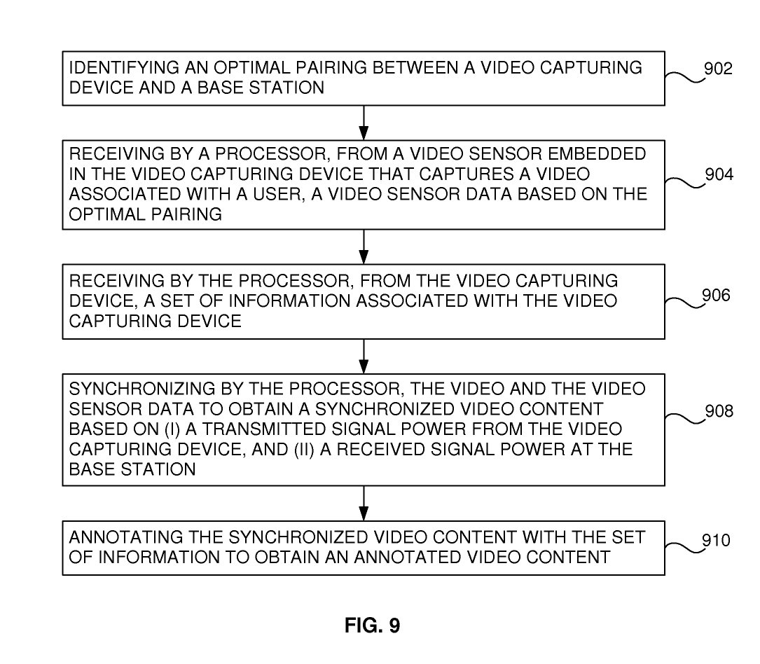

FIG. 9, with reference to FIGS. 1 through 8, is a flow diagram illustrating a method for automatically annotating a multimedia content at the base station 106 of FIG. 1 according to an embodiment herein. In step 902, an optimal pairing between a video capturing device and a base station is identified. In step 904, a video sensor data is received by a processor from a video sensor embedded in the video capturing device that captures a video associated with a user based on the optimal pairing. The video sensor data includes a time series of location data, direction data, orientation data, and a position of the user. In step 906, a set of information associated with the video capturing device is received by the processor from the video capturing device. The set of information includes at least one of a current memory level, a current power level, a range data, a location data, an orientation data, lighting, and or identifier. In step 908, the video and the video sensor is synchronized to obtain a synchronized video content based on (i) a transmitted signal power from the video capturing device, and (ii) a received signal power at the base station 106. In step 910, the synchronized video content is annotated with the set of information to obtain an annotated video content.

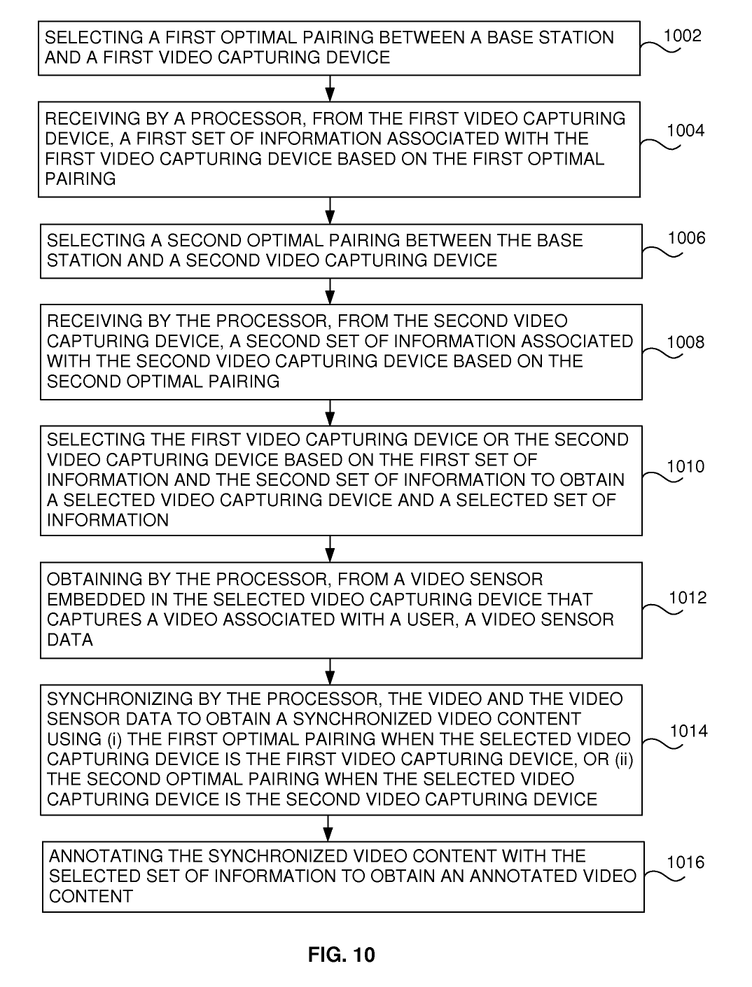

FIG. 10, with reference to FIGS. 1 through 9, is a flow diagram illustrating a method for automatically annotating a multimedia content obtained from at least one video capturing device including the first video capturing device 104A and the second capturing device 104B at the base station 106 of FIG. 1 according to an embodiment herein. In step 1002, a first optimal pairing is selected between a base station and the first video capturing device 104A. In step 1004, a first set of information associated with the first video capturing device 104A is received by a processor from the first video capturing device 104A based on the first optimal pairing. The first set of information includes at least one of a current memory level, a current power level, a range data, a location data, an orientation data, lighting, and an identifier. In step 1006, a second optimal pairing is selected between the base station and the second video capturing device 104B. In step 1008, a second set of information associated with the second video capturing device 104B is received by the processor from the second video capturing device 104B based on the second optimal pairing. The second set of information includes at least one of a current memory level, a current power level, a range data, a location data, an orientation data, lighting, and an identifier.

In step 1010, the first video capturing device 104A or the second video capturing device 104B is selected based on the first set of information and the second set of information to obtain a selected video capturing device and a selected set of information. In step 1012, a video sensor data is obtained by the processor from a video sensor embedded in the selected video capturing device that captures a video associated with a user. The video sensor data includes a time series of location data, direction data, orientation data, and a position of the user. In step 1014, the video and the video sensor data is synchronized to obtain a synchronized video content using (i) the first optimal pairing when the selected video capturing device is the first video capturing device 104A, or (ii) the second optimal pairing when the selected video capturing device is the second video capturing device 104B. In step 1016, the synchronized video content is annotated with the selected set of information to obtain an annotated video content.

The first video capturing device 104A and the second video capturing device 104B capture raw video data and buffer it in a RAM while transmitting uncompressed video short ranges to the base station 106 using 60 Gigahertz low power wireless transmission, which is very fast and efficient provided there are no obstacles that absorb the signal and the range is short. 60 GHz also bounces off of walls and objects, resulting in multiple potential pattern and echoes in transmission. Power requirements are kept low for transmission with pattern forming techniques known in the art, where multi-antenna transceivers choose the best pattern for the clearest signal to the transmitting device, lowering the transmission power requirements.

Transmission power requirements can be further reduced with location and orientation information from the camera and the base station 106 combined with machine learning approaches to pattern finding. The orientation and location information can be features that the model fits with regression techniques to use the orientation data to predict an optimal pairing.

Data transmission from the video capturing devices includes real-time annotations with video capturing device settings data (e.g., the first set of information, the second set of information and the third set of information), range data, lighting data, location and absolute orientation data. The video capturing devices can also store data locally and then transmit data when sufficient bandwidth is available. Local buffers and memory can be cleared automatically when acknowledgement is received by the video capturing devices from the base station 106 that the data was transmitted without any error. The recorded signal, power and the radiation pattern and the sensitivity pattern are used in combination with sensor data to generate situational (or contextual) information for the annotation. The radiation patterns and sensitivity patterns could be trivial, complicated, sub-optimal or optimal, beam-like or lobe-like.

For multiple video capturing device shoots, the above embodiments enable data to be transmitted to the base station 106 depending in parallel if there is sufficient bandwidth, or taking turns between the video capturing devices. For the taking turn's method, when a channel is in use, a video capturing device saves data to buffer or flash memory. Channel priority is allocated based on which video capturing device has greatest need for available memory and power. Thus, the base station 106 allows the production team to know at all times what the battery and local storage levels are on the field, so that unexpected interruptions are minimized. The above methodology also enables sound recorders or microphones to be included in the transmission from the video capturing devices or from stand-alone microphone units. There are vectors of data streaming in, and there is a need to do pattern matching and classification. This is a system that can be trained as the initial suggestions to the user are trained over time much. For example, the system can be trained in a manner similar to how spam filters are trained on email systems and services. The system also used to map that high level contextual annotation to lower level technologies that can physically add to cameras and broadband wireless networks where cameras can be used. Based on a position associated with a camera enhances the annotation. The annotation system can record signal strength, the antenna settings (e.g., which implies the radiation pattern and the sensitivity patters for both cameras and base stations), and incorporate these into the annotation. Similarly, when the annotation gets processed, an estimate of the camera positions can be computed an added into the notes. Then the base stations can adjust their antenna or recommend other base stations given the requirements of the shot, and send a notification for failure.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A method for automatically annotating a multimedia content at a base station, said method comprising:
identifying, an optimal pairing between a video capturing device and said base station;
receiving by a processor, from a video sensor embedded in said video capturing device that captures a video associated with a user, a video sensor data based on said optimal pairing, wherein said video sensor data comprises a time series of location data, direction data, orientation data, and a position of said user;
receiving by said processor, from said video capturing device, a set of information associated with said video capturing device, wherein said set of information comprises at least one of a current memory level, a current power level, a range data, a location data, an orientation data, lighting, and or identifier;
synchronizing by said processor, said video and said video sensor data to obtain a synchronized video content based on (i) a transmitted signal power from said video capturing device, and (ii) a received signal power at said base station; and
annotating said synchronized video content with said set of information to obtain an annotated video content.

2. The method of claim 1, further comprising recording a radiation pattern associated with said video capturing device and a sensitivity pattern associated with said base station, wherein said radiation pattern and said sensitivity pattern are beam-like, lobe-like or spherical.

3. The method of claim 1, further comprising performing a comparison between said annotated video content and production data obtained from a production data server, and automatically generating recommended digital notes based on said comparison.

4. The method of claim 1, further comprising:
receiving, by said processor, at least one user suggested digital notes from a user;
associating said annotated video content with said at least one user suggested digital notes.

5. The method of claim 3, wherein said production data is selected from the group comprising of a script, scenes, characters, camera operators, a shoot schedule, call times, digital notes, background information and research notes.

6. The method of claim 1, further comprising transmitting from said base station to said video capturing device, an acknowledgement when said video, said video sensor data, and said set of information are received at said base station, wherein at least one of said video, said video sensor data, or said set of information is erased from a memory of said video capturing device based on said acknowledgement.

7. The method of claim 1, further comprising recording a radiation pattern associated with said base station and a sensitivity pattern associated with said video capturing device, wherein said radiation pattern and said sensitivity pattern are beam-like, lobe-like, or spherical.

8. The method of claim 7, further comprising localizing said video capturing device in an environment or with respect to said base station based on said radiation pattern of said base station and said sensitivity pattern of said video capturing device.

9. The method of claim 8, further comprising identifying said radiation pattern of said base station based on a signal receiving power, said location data, and said orientation data obtained from said video capturing device from at least one location.

10. A method for automatically annotating multimedia content obtained from at least one video capturing device comprising a first video capturing device and a second capturing device at a base station, said method comprising:
selecting a first optimal pairing between said base station and said first video capturing device;
receiving by said processor, from said first video capturing device, a first set of information associated with said first video capturing device based on said first optimal pairing, wherein said first set of information comprises at least one of a current memory level, a current power level, a range data, a location data, an orientation data, lighting, and an identifier;
selecting a second optimal pairing between said base station and said second video capturing device;
receiving by said processor, from said second video capturing device, a second set of information associated with said second video capturing device based on said second optimal pairing, wherein said second set of information comprises at least one of a current memory level, a current power level, a range data, a location data, an orientation data, lighting, and an identifier;
selecting said first video capturing device or said second video capturing device based on said first set of information and said second set of information to obtain a selected video capturing device and a selected set of information;
obtaining by said processor, from a video sensor embedded in said selected video capturing device that captures a video associated with a user, a video sensor data comprising a time series of location data, direction data, orientation data, and a position of said user;
synchronizing by said processor, said video and said video sensor data to obtain a synchronized video content using (i) said first optimal pairing when said selected video capturing device is said first video capturing device, or (ii) said second optimal pairing when said selected video capturing device is said second video capturing device; and
annotating said synchronized video content with said selected set of information to obtain an annotated video content.

11. The method of claim 10, wherein said first set of information comprises at least one of the radiation pattern associated with said first video capturing device, and the sensitivity pattern associated with said base station, and wherein said radiation pattern and said sensitivity pattern are beam-like, lobe-like, or spherical.

12. The method of claim 10, wherein said second set of information comprises at least one of the radiation pattern associated with said second video capturing device, and the sensitivity pattern associated with said base station, and wherein said radiation pattern and said sensitivity pattern are beam-like, lobe-like, or spherical.

13. The method of claim 10, further comprising performing a comparison between said annotated video content and production data obtained from a production data server.

14. The method of claim 13, further comprising automatically generating recommended digital notes based on said comparison.

15. The method of claim 10, further comprising transmitting from said base station to said selected video capturing device, an acknowledgement when said video, said video sensor data, and said selected set of information are received at said base station, wherein at least one of said video, said video sensor data, and said selected set of information is automatically erased from a memory of said selected video capturing device based on said acknowledgement.

16. A base station for automatically annotating multimedia content obtained from an at least one video capturing device comprising a first video capturing device and a second capturing device, said base station comprising:
a memory that stores instructions and a database;
a processor executed by said instructions;
an optimal pair selection module which when executed by said processor selects (i) a first optimal pairing between said base station and said first video capturing device, and (ii) a second optimal pairing between said base station and said second video capturing device;
a video capturing device information receiving module when executed by said processor, receives a first set of information from said first video capturing device based on said first optimal pairing and a second set of information from said second video capturing device based on said second optimal pairing, wherein said first set of information is selected from the group comprising of a current memory level, a current power level, a range data, a location data, an orientation data, lighting, and an identifier specific to said first video capturing device, and wherein said second set of information is selected from the group comprising of a current memory level, a current power level, a range data, a location data, an orientation data, lighting, and an identifier specific to said second video capturing device;
a device selection module when executed by said processor selects said first video capturing device or said second video capturing device based on said first set of information and said second set of information to obtain a selected video capturing device and a selected set of information;
a sensor data obtaining module when executed by said processor obtains from a video sensor embedded in said selected video capturing device that captures a video associated with a user, a video sensor data comprising a time series of location data, direction data, orientation data, and a position of said user;
a synchronization module when executed by said processor, synchronizes said video and said video sensor data to obtain a synchronized video content using (i) said first optimal pairing when said selected video capturing device is said first video capturing device, or (ii) said second optimal pairing when said selected video capturing device is said second video capturing device; and
an annotation module when executed by said processor annotates said synchronized video content with said selected set of information to obtain an annotated video content.

17. The base station of claim 16, wherein said first set of information comprises at least one of the radiation pattern associated with said first video capturing device, and the sensitivity pattern associated with said base station, and wherein said radiation pattern and said sensitivity pattern are beam-like, lobe-like, or spherical.

18. The base station of claim 16, wherein said second set of information comprises at least one of the radiation pattern associated with said second video capturing device, and the sensitivity pattern associated with said base station, and wherein said radiation pattern and said sensitivity pattern are beam-like, lobe-like, or spherical.

19. The base station of claim 16, further comprising a comparison module when executed by said processor performs a comparison of said annotated video content and production data obtained from a production data server.

20. The base station of claim 19, further comprising a digital notes generation module when executed by said processor automatically generates recommended digital notes based on said comparison.

21. The base station of claim 20, wherein at least one user suggested digital notes is received from a user, and said annotated video content is associated with said at least one user suggested digital notes instead of said recommended digital notes.

22. The base station of claim 21, further comprising an audio capturing device information obtaining module that obtains an audio from an audio capturing device, wherein said sensor data obtaining module obtains an audio sensor data from an audio sensor coupled to said audio capturing device, wherein said audio is specific to said user, wherein said synchronization module when executed by said processor further synchronizes said video, said video sensor data, said audio, said audio sensor data, and said production data to obtain said synchronized video content.

23. The base station of claim 21, further comprising a self-learning module when executed by said processor learns a pattern of annotating video content, and generating recommended digital notes based on at least one of said synchronized video content, said at least one user suggested digital notes, said recommended digital notes, and previously annotated video content.

24. The base station of claim 146 further comprising a communication module when executed by said processor transmits from said base station to said selected video capturing device, an acknowledgement when said video, said video sensor data, and said selected set of information are received at said base station, wherein at least one of said video, said video sensor data, and said selected set of information is automatically erased from a memory of said selected video capturing device based on said acknowledgement.

25. The base station of claim 16, wherein said optimal pairing selection module when executed by said processor
(i) focuses a radiation pattern of said first video capturing device;
(ii) orients said base station to receive a signal from said first video capturing device;
(iii) monitors said signal from said first video capturing device to determine an optimal power of said signal; and
(iv) selects said first optimal pair between said base station and said first video capturing device corresponding to said optimal power of said signal.

26. The base station of claim 16, wherein said optimal pairing selection module when executed by said processor
(i) focuses a radiation pattern of said second video capturing device;
(ii) orients said base station to receive a signal from said second video capturing device;
(iii) monitors said signal from said second video capturing device to determine an optimal power of said signal; and
(iv) selects said second optimal pair between said base station and said second video capturing device corresponding to said optimal power of said signal.
